(19) United States
(12) Patent Application Publication
(10) Pub. No.: US 2020/0214330 A1
(43) Pub. Date: Jul. 9, 2020

(54) RICE PROTEIN HYDROLYSATES WITH ANTI-INFLAMMATORY PROPERTIES

(71) Applicant: ABBOTT LABORATORIES, Abbott Park, IL (US)

(72) Inventors: Stephen DEMICHELE, Dublin, OH (US); Jeffrey BAXTER, Grayling, MI (US); Paul JOHNS, Columbus, OH (US); Normanella DEWILLE, Columbus, OH (US); Daniel SLIVA, Indianapolis, IN (US)

(21) Appl. No.: 16/627,559

(22) PCT Filed: Jul. 18, 2018
(86) PCT No.: PCT/US2018/042633

§ 371 Date: Dec. 30, 2019

Related U.S. Application Data
(60) Provisional application No. 62/535,489, filed on Jul. 21, 2017.

(51) Int. Cl. A23L 33/18; A23L 33/12; A23L 33/155; A23L 33/00

(52) U.S. Cl. CPC A23L 33/18; A23L 33/40; A23L 33/155; A23L 33/12

(57) ABSTRACT

Nutritional compositions for modulating or reducing inflammation in an individual in need. The nutritional compositions can include a rice protein hydrolysate having a minimum degree of hydrolysis of 15%, where at least 30% of the rice protein hydrolysate peptides are less than 1000 Da., and no more than 30% of the rice protein peptides are greater than 3000 Da.

### TECHNICAL FIELD

The present disclosure relates to rice protein hydrolysates for modulating inflammation in an individual. More particularly, the present disclosure relates to nutritional compositions comprising rice protein hydrolysates that in specific embodiments reduce inflammation and thereby prevent and/or treat inflammatory conditions and diseases.

### BACKGROUND

Excessive inflammation is widely understood to be a unifying component in many chronic diseases, including vascular diseases, metabolic syndrome, and neurological diseases. Understanding endogenous control points within the inflammatory response could provide new perspectives on disease pathogenesis and treatment approaches. The acute inflammatory response generally has an initiation (early phase) and resolution (late phase). The production of inflammatory cytokines (i.e., Tumor Necrosis Factor alpha, TNFα) is part of the inflammatory process which is characterized by an initial and then a sustained phase that usually ends after resolution of the inflammatory trigger. Often, a breakdown in the regulation of inflammation occurs at the end of sustained inflammatory responses and prolonged TNFα production is often associated with the pathology of many inflammatory diseases. Many therapeutic pharmaceutical agents block or antagonize the initiation steps of acute inflammation but do not have an effect on the late phase resolving inflammation. Therefore the identification of key regulators of sustained TNFα production would provide opportunities to develop new therapeutic inventions for inflammatory diseases.

Prior research does not provide a way to formulate a nutritional product using hydrolyzed proteins without adversely affecting the organoleptic properties of the product, and in particular, taste. Other problems to the development of such products include precipitation difficulties and bitter, salty, sour, and/or beany flavors.

It would therefore be desirable to provide nutritional compositions with components such as moderately hydrolyzed rice proteins that act on only a portion of the inflammatory response, or more predominantly in one phase of the inflammatory response, while still providing the organoleptic properties that consumers have come to expect (i.e., flavor and texture profiles).

### SUMMARY

Specific embodiments of the invention are generally directed to a nutritional composition for modulating or reducing inflammation in an individual in need thereof, the nutritional composition comprising a rice protein hydrolysate having a minimum degree of hydrolysis of 15%, wherein at least 30% of the rice protein hydrolysate peptides are less than 1000 Da., and no more than 30% of the rice protein hydrolysate peptides are greater than 3000 Da.

Additional embodiments are directed to a method of modulating inflammation in an individual, the method comprising administering to the individual a nutritional composition comprising a rice protein hydrolysate having a minimum degree of hydrolysis of 15%, wherein at least 30% of the rice protein hydrolysate peptides are less than 1000 Da., and no more than 30% of the rice protein hydrolysate peptides greater than 3000 Da.

Specific embodiments are directed to a method of modulating inflammation in an individual, the method comprising administering to the individual a rice protein hydrolysate having a minimum degree of hydrolysis of 15%, wherein at least 30% of the rice protein hydrolysate peptides are less than 1000 Da., and no more than 30% of the rice protein hydrolysate peptides greater than 3000 Da.

### BRIEF DESCRIPTION OF THE DRAWINGS

The embodiments set forth in the drawings are illustrative and exemplary in nature and not intended to limit the invention defined by the claims. The following detailed description of the illustrative embodiments can be understood when read in conjunction with the following drawings, in which:

FIG. 1 illustrates in vitro early phase inhibition of TNFα secretion (measured 6 hours after LPS stimulation) from macrophage cells (RAW264.7) pre-incubated for 1 hour with either rice protein hydrolysate form 1 (RPH-1) or intact rice protein and then treated with lipopolysaccharide (LPS);

FIG. 2 illustrates in vitro late phase inhibition of TNFα secretion (measured 24 hours after LPS stimulation) from macrophage cells (RAW264.7) pre-incubated for 1 hour with either RPH-1 or intact rice protein and then treated with LPS;

FIG. 3 illustrates in vitro early phase 4-1BBL expression (measured 6 hours after LPS stimulation) in macrophage cells (RAW264.7) pre-incubated for 1 hour with either RPH-1 or intact rice protein and treated with LPS;

FIG. 4 illustrates in vitro late phase 4-1BBL expression (measured 24 hours after LPS stimulation) from macrophage cells (RAW264.7) pre-incubated for 1 hour with either RPH-1 or intact rice protein and then treated with LPS:

FIG. 5 illustrates in vitro early (6 hours after LPS stimulation) and late phase (24 hours after LPS stimulation) inhibition of 4-1BBL expression in macrophage cells (RAW264.7) pre-incubated for 1 hour with RPH-land then treated with LPS;

FIG. 6 illustrates in vitro NF-κB activation (30 min after LPS stimulation) in macrophage cells (RAW264.7) preincubated for 2 hours with RPH-1 and then treated with LPS;

FIG. 7 illustrates in vitro early phase inhibition of TNFα secretion (6 hours after LPS stimulation) from macrophage cells (RAW264.7) pre-incubated for 1 hour with either RPH-1, RPH-2 (rice protein hydrolysate-2) or intact rice protein and then treated with LPS;

FIG. 8 illustrates in vitro late phase inhibition of TNFα secretion (24 hours after LPS stimulation) from macrophage cells (RAW264.7) pre-incubated for 1 hour with either RPH-1, RPH-2 (rice protein hydrolysate-2) or intact rice protein and then treated with LPS;

FIG. 9 illustrates in vitro early phase 4-1BBL expression (6 hours after LPS stimulation) in macrophage cells (RAW264.7) pre-incubated for 1 hour with either RPH-2 or intact rice protein and then treated with LPS;

FIG. 10 illustrates in vitro late phase 4-1BBL expression (24 hours after LPS stimulation) in macrophage cells (RAW264.7) pre-incubated for 1 hour with either RPH-2 or intact rice protein and then treated with LPS;

FIG. 11 illustrates in vitro early (6 hours after LPS stimulation) and late (24 hours after LPS stimulation) phase inhibition of TNFα secretion from macrophage cells (RAW264.7) pre-incubated with different levels of curcumin for 1 hour and then treated with LPS;

FIG. 12 illustrates in vitro early (6 hours after LPS stimulation) and late (24 hours after LPS stimulation) phase inhibition of 4-1BBL expression in macrophage cells (RAW264.7) pre-incubated for 1 hour with different levels of curcumin and then treated with LPS;

FIG. 13 illustrates in vitro inhibition of nuclear factor kappa-light-chain-enhancer of activated B cells (NF-κB) activation in macrophage cells (RAW264.7) pre-incubated with curcumin for 2 hours and treated with LPS for 30 minutes;

FIG. 14 illustrates in vivo inhibition of TNFα secretion in plasma (median values) in mice treated with RPH-1 and LPS;

FIG. 15 illustrates in vivo inhibition of 4-1BBL secretion in plasma in mice treated with RPH-1 and LPS.

### DETAILED DESCRIPTION

Specific embodiments of the present disclosure will now be described. The invention can, however, be embodied in different forms and should not be construed as limited to the embodiments set forth herein. Rather, these embodiments are provided to illustrate more specific features of certain aspects of the invention to those skilled in the art.

Unless otherwise defined, all technical and scientific terms used herein have the same meaning as commonly understood by one of ordinary skill in the art to which embodiments of this invention belong. The terminology used herein is for describing particular embodiments only and is not intended to be limiting of the invention. As used in the specification and appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about,” which is intended to mean up to ±10% of an indicated value. Additionally, the disclosure of any ranges in the specification and claims are to be understood as including the range itself and also anything subsumed therein, as well as endpoints. Numerical ranges as used herein are intended to include every number and subset of numbers within that range, whether specifically disclosed or not. Unless otherwise indicated, the numerical properties set forth in the specification and claims are approximations that can vary depending on the desired properties sought to be obtained in embodiments of the present invention. Notwithstanding that numerical ranges and parameters setting forth the broad scope of embodiments of the invention are approximations, the numerical values set forth in the specific examples are reported as precisely as possible. Any numerical values, however, inherently contain certain errors necessarily resulting from error found in their respective measurements.

The nutritional compositions and methods described herein utilize rice proteins, especially rice protein hydrolysates, as a part of a nutritional composition. In certain embodiments, the nutritional compositions comprise rice protein hydrolysates as a sole protein source. Certain exemplary embodiments contemplate compositions comprising at least one moderately hydrolyzed rice protein in combination with at least one of: long chain polyunsaturated fatty acids; polyphenols; curcuminoids; antioxidants, including carotenoids, and/or various other immunomodulatory or anti-inflammatory ingredients for controlling diseases and conditions related to inflammation.

These and other features of the nutritional compositions and methods, as well as some of the many optional variations and additions, are described in detail hereafter.

The terms “fat” and “oil” as used herein, unless otherwise specified, are used interchangeably to refer to lipid materials derived or processed from plants or animals. These terms also include synthetic lipid materials so long as such synthetic materials are suitable for oral administration to humans.

The term “shelf stable” as used herein, unless otherwise specified, refers to a nutritional composition that remains commercially stable after being packaged and then stored at 18-24° C. for at least 3 months, or from about 6 months to about 36 months, or from about 12 months to about 18 months.

The term “nutritional composition” as used herein, unless otherwise specified, refers to synthetic formulas including nutritional liquids, nutritional powders, nutritional solids, nutritional semi-solids, nutritional semi-liquids, nutritional supplements, and any other nutritional food composition as known in the art. The nutritional powders in specific embodiments are reconstituted to form a nutritional liquid, all of which comprise one or more of protein, fat, and carbohydrate and are suitable for oral consumption by a human.

The term “nutritional liquid” as used herein, unless otherwise specified, refers to nutritional compositions in ready-to-drink liquid form, concentrated form, and nutritional liquids made by reconstituting the nutritional powders described herein prior to use. In one example, the liquid is a shake.

The term “nutritional powder” as used herein, unless otherwise specified, refers to nutritional compositions in flowable or scoopable form that in specific embodiments are reconstituted with water or another aqueous liquid prior to consumption and includes both spray dried and drymixed/dryblended powders.

The term “nutritional semi-solid,” as used herein, unless otherwise specified, refers to nutritional compositions that are intermediate in properties, such as rigidity, between solids and liquids. Some semi-solids examples include puddings, gelatins, and doughs.

The term “nutritional semi-liquid,” as used herein, unless otherwise specified, refers to nutritional compositions that are intermediate in properties, such as flow properties, between liquids and solids.

The term “synthetic pediatric formula” as used herein, unless otherwise specified, refers to liquid, semi-liquid, solid, and semi-solid human milk replacements or substitutes that are suitable for consumption by an infant or toddler up to the age of 36 months (3 years).

The term “synthetic child formula” as used herein, unless otherwise specified, refers to liquid, semi-liquid, solid, and semi-solid human milk replacements or substitutes that are suitable for consumption by a child up to the age of 12 years.

The terms “inflammatory disease” or “inflammatory condition” as used herein, unless otherwise specified, refer to any disease, disorder, or condition characterized by inflammation. Non-limiting examples include vascular diseases, metabolic syndrome, obesity, and neurological diseases, diabetes, and diseases of the gastrointestinal tract, nerves, lungs, skin, muscles, bones, brain, thyroid, blood, cancer, and certain aspects of aging.

The terms “susceptible” and “at risk” as used herein, unless otherwise specified, mean having resistance to a certain condition or disease that is reduced relative to the population as a whole, including being genetically predisposed, having a family history of, and/or having symptoms of the condition or disease.

The terms “modulating” or “modulation” or “modulate” as used herein, unless otherwise specified, refer to the targeted movement of a selected characteristic.

The terms “hydrolyzed protein” or “protein hydrolysate” as used herein, unless otherwise specified, refer to a source of protein which has been subjected to a specific treatment whose primary purpose is to hydrolyze proteins. In this regard, it is conventional in this industry to refer to a protein source which has been subjected to a treatment whose primary purpose is to hydrolyze unhydrolyzed proteins as a source of hydrolyzed proteins, e.g., “rice protein hydrolysate.” In contrast, when a protein source has not been subjected to such a treatment, it is conventional practice to refer to this composition as a source of intact protein, or, more commonly, to say nothing about the hydrolysis of its protein.

A way of referring to the extent of hydrolysis of a hydrolyzed protein is by noting its Degree of Hydrolysis (DH). A protein with a DH value of, for example, 30 refers to protein in which 30% of the total protein is hydrolyzed (or that 30% of the protein's peptide bonds have been cleaved; e.g., if the intact protein contains 100 peptide bonds, and if 30 of these bonds are cleaved by the hydrolysis process, then the DH of the protein after hydrolysis is 30).

The inflammatory response is generally divided into an early phase and a late phase. The early phase refers to acute inflammation that includes all the events of the acute vascular response that follows within seconds of the tissue injury and last for some minutes, and the acute cellular response that takes place over the next few hours. The hallmark of this phase is the appearance of granulocytes, particularly neutrophils, in the tissues. The late phase refers to chronic inflammation and resolution. Chronic inflammation includes a response occurring a day or days after the injury, and is marked by the appearance of a mononuclear cell infiltrate composed of macrophages and lymphocytes. The macrophages are involved in microbial killing, clearing cellular and tissue debris, and in remodeling the tissue. Resolution refers to tissue returning to normal or developing scarring. Complete resolution of an acute inflammatory response and the return of local tissues to homeostasis is an aim for the process, minimizing inflammation's impact to ongoing health.

Surprisingly, it has been found that a moderately hydrolyzed protein ingredient from rice is capable of modulating the late phase inflammatory response without presenting organoleptic issues that are common to hydrolyzed proteins such as undesirable odor or taste. As used herein, “moderately hydrolyzed” refers to a protein hydrolyzed to a DH of at least 15%.

It is well understood that the TLR4-MYD88-TRIF signaling pathway is responsible for the initiation and early phase expression of genes encoding for specific pro-inflammatory cytokines (e.g., TNFα). Another important protein induced during the early phase of T lymphocyte-mediated (TLR-mediated) cellular activation is 4-1BB ligand (4-1BBL, also referred to as CD137L). 4-IBBL is produced on the cell surface of specific macrophages/T cells and functions to generate a new phase of signaling to mediate sustained TNFα production. 4-1BBL is a type 2 trans membrane protein of the TNFα super family. The interaction between 4-1BBL and its receptors provides a co-stimulatory signal enhancing T lymphocytes proliferation and survival, required for sustained TNFα production in macrophages and is rapidly induced in LPS stimulated macrophages.

While not wishing to be bound by theory, it is contemplated that moderately hydrolyzed rice protein from particular sources in specific embodiments inhibit or reduce expression of 4-1BBL and thereby reduce the duration of TNFα production. Long term elevation of pro-inflammatory cytokines (such as TNFα) is often associated with the pathology of inflammatory diseases. Targeted reductions of the late phase 4-1BBL mediated TLR signaling in specific embodiments provide a strategy for treatment of inflammatory diseases while not suppressing the inflammatory response as a whole. In addition, since the moderately hydrolyzed proteins of the present disclosure do not suppress the activation of NF-κB (an early phase response), in specific embodiments, synergistic anti-inflammatory effects are provided by combining these bioactive moderately hydrolyzed proteins with known early phase NF-κB inhibitors, such as curcumin (for example, C3C curcumin), green tea extract, and others.

The present disclosure is directed to nutritional compositions in the form of nutritional liquids, powders, bars, and other food products comprising rice protein hydrolysates as a primary or sole source of protein. The rice protein hydrolysate has a degree of hydrolysis such that the resulting nutritional compositions are physically stable over shelf life and provide favorable organoleptic properties, while providing surprising anti-inflammatory properties.

The nutritional compositions of the present disclosure include one or more rice protein hydrolysates as described herein. The compositions in specific embodiments include one or more rice protein hydrolysates alone or in combination with other immune-modulating or anti-inflammatory ingredients including, but not limited, to long chain polyunsaturated fatty acids (LCPUFAs), polyphenols, anthocyanidins, curcuminoids, isoflavones, and antioxidants, such as carotenoids and vitamins, as discussed below. More specific examples of immune-modulating or anti-inflammatory ingredients that inhibit an early phase of inflammation and in specific embodiments are combined with the rice protein hydrolysates of the present disclosure to provide synergistic inflammatory benefits to a consumer include: turmeric, lutein, lycopene, zeaxanthin, luteolin, resveratrol, epigallocatechin gallate, quercetin, hydroxytyrosol (including tyrosol), astaxanthin, fisetin, conjugated linoleic acid, 6-gingerol, vitamin E, pterostilbine, pycnogenol, omega-3 fatty acids, genistein, liquiritigenin, liquiritin, ellagic acid, ursolic acid, naringenin, cocoa polyphenols, eugenol, helenalin, cinnamaldehyde, and sulphoraphane, among others. The compositions can include green tea catechins.

### Product Form

The nutritional compositions of the present disclosure, which include rice protein hydrolysates as described herein, in specific embodiments are formulated and administered in any known or otherwise suitable oral product form. Any solid, liquid, or powder form, including combinations or variations thereof, are suitable for use herein, provided that such forms allow for safe and effective oral delivery to the individual of ingredients as also defined herein.

The nutritional compositions in specific embodiments include rice protein hydrolysates as the sole source of protein (i.e., rice protein hydrolysates are up to 100% of the protein component of the composition) or they include rice protein hydrolysates in combination with other hydrolyzed, partially hydrolyzed, or unhydrolyzed (intact) proteins as described and suggested herein. The nutritional compositions in specific embodiments are formulated to include optional ingredients to form a number of different product forms.

The nutritional compositions of the present disclosure in specific embodiments include a variety of different product forms, including any conventional or otherwise known food product form, some non-limiting examples of which include confectionary products, cereals, food condiments (e.g., spreads, powders, sauces, jams, jelly, coffee creamer or sweetener), pasta, baking or cooking materials (e.g., flour, fats or oils, butter or margarine, breading or baking mixes), salted or seasoned snacks (e.g., extruded, baked, fried), beverages (e.g., coffee, juice, carbonated beverage, non-carbonated beverage, tea, energy shots and/or other forms of energy drinks including drinks with caffeine and/or vitamins, and the energy drinks in specific embodiments are from about 1 to about 2 ounces per serving, and each serving contains from about 50 mg to 500 mg of caffeine per serving), snack or meal replacement bars (e.g., Ensure™ bars, Zone Perfect™ bars, and Glucerna™ bars), smoothies, breakfast cereals, cheeses, gummie products, salted or unsalted crisp snacks (e.g., chips, crackers, pretzels), dips, baked goods (e.g., cookies, cakes, pies, pastries, bread, bagels, croutons), dressings, dry mixes (e.g., mixes for muffins, cookies, waffles, pancakes, beverages), frozen desserts (e.g., ice cream, popsicles, fudge bars, crushed ice, frozen yogurt), pasta, processed meats (e.g., corn dogs, hamburgers, hotdogs, sausage, pepperoni), pizza, pudding, flavored or unflavored gelatin, refrigerated dough (e.g., cookies, bread, brownies), yogurt or yogurt-based drinks, frozen yogurt, soups, vegetable-based burgers, and popcorn-based snacks.

The nutritional compositions of the present disclosure in specific embodiments are formulated in product forms such as capsules, tablets, pills, caplets, gels, liquids (e.g., suspensions, solutions, emulsions, or clear solutions), powders or other particulates, and so forth. These product forms in specific embodiments optionally contain other actives, processing aids or other dosage form excipients.

The nutritional compositions in specific embodiments are formulated with sufficient kinds and amounts of nutrients to provide a sole, primary, or supplemental source of nutrition, or to provide a specialized nutritional composition for use in individuals afflicted with specific diseases or conditions or with a targeted nutritional benefit.

Specific non-limiting examples of product forms suitable for use with the hydrolyzed rice protein-containing compositions as disclosed herein include, for example, liquid and powdered dietary supplements, liquid and powdered human milk fortifiers, liquid and powdered infant formulas, liquid and powdered elemental and semi-elemental formulas, liquid and powdered pediatric formulas, liquid and powdered toddler formulas, and nutritional bars.

The nutritional compositions of the present disclosure, when formulated as a dietary product form, in specific embodiments potentially provide either a sole source or a supplemental source of nutrition to an individual. In this context, a sole source of nutrition is one that in specific embodiments is administered once or multiple times each day (such as 2, 3, 4, etc.) to potentially provide an individual with all or substantially all their protein, fat, carbohydrate, mineral, and vitamin needs per day or during the intended period of administration. In specific embodiments the nutritional composition is administered to an individual diagnosed as having inflammation, or to an individual at risk of having inflammation. In specific embodiments the nutritional composition is provided to an individual identified as about to undergo a medical procedure that would lead to inflammation, and the nutritional composition is provided before the medical procedure (such as 1, or 2, or 3, or about 5 to about 10 days prior to the procedure), and/or during the medical procedure and/or after the procedure is performed. The medical procedure in specific embodiments is surgery and/or angioplasty and/or insertion of a stent. A supplemental source of nutrition is defined herein as a dietary source that does not provide an individual with a potentially sole source of nutrition.

### Nutritional Liquids

Nutritional liquids include both concentrated and ready-to-feed nutritional liquids. These nutritional liquids are most typically formulated as suspensions or emulsions, although other liquid forms are within the scope of the present disclosure.

Nutritional emulsions suitable for use in specific embodiments are aqueous emulsions comprising proteins, fats, and carbohydrates. These emulsions are generally flowable or drinkable liquids and are typically in the form of oil-in-water, water-in-oil, or complex aqueous emulsions, although such emulsions are most typically in the form of oil-in-water emulsions having a continuous aqueous phase and a discontinuous oil phase.

The nutritional emulsions are shelf stable. The nutritional compositions in specific embodiments contain up to about 95% by weight of water, or from about 50% to about 95%, or from about 60% to about 90%, or from about 70% to about 85%, of water by weight of the nutritional composition. The nutritional composition in specific embodiments have a variety of product densities, including a density greater than about 1.03 g/mL, or greater than about 1.04 g/mL, or greater than about 1.055 g/mL. The nutritional composition density in specific embodiments is from about 1.06 g/mL to about 1.12 g/mL, or from about 1.085 g/mL to about 1.10 g/mL.

The nutritional emulsions in specific embodiments have a caloric density tailored to the nutritional needs of the ultimate user. In specific embodiments the emulsions comprise at least 19 kcal/fl oz (660 kcal/liter), or from about 20 kcal/fl oz (675-680 kcal/liter) to about 25 kcal/fl oz (820 kcal/liter), or from about 20 kcal/fl oz (675-680 kcal/liter) to about 24 kcal/fl oz (800-810 kcal/liter). In some embodiments, the emulsion in specific embodiments have a caloric density from about 50-100 kcal/liter to about 660 kcal/liter, or from about 150 kcal/liter to about 500 kcal/liter. In specific embodiments, the emulsion has a caloric density of 25, or 50, or 75, or 100 kcal/liter. Embodiments described herein are used in chronic tube feeding of adults, and include from about 1000 kcal/liter to about 1500 kcal/liter, or from about 1000 kcal/liter to about 2000 kcal/liter, or from about 1200 to about 1800 kcal/liter. Certain embodiments envision target volumes per day of about 750 to about 1500 ml, administered in multiple, divided boluses, the divided bolus volume determined by patient volume tolerance, each bolus intended to deliver an effective dosage to reduce inflammation.

The nutritional emulsion in specific embodiments has a pH range from about 3.5 to about 8, or a range of from about 4.5 to about 7.5, or from about 5.5 to about 7.3, or from about 6.2 to about 7.2.

Although the serving size for the nutritional emulsion in specific embodiments varies depending upon a number of variables, a serving size in specific embodiments is at least about 1 mL, or at least about 2 mL, or at least about 5 mL, or at least about 10 mL, or at least about 25 mL, including a range from about 1 mL to about 500 mL, or from about 4 mL to about 250 mL, or from about 10 mL to about 240 mL.

### Nutritional Solids

The nutritional solids in specific embodiments are in any solid form but are typically in the form of flowable or substantially flowable particulate compositions, or at least particulate compositions. Particularly suitable nutritional solid composition forms include spray dried, agglomerated and/or dryblended powder compositions. The compositions in specific embodiments are easily be scooped and measured with a spoon or similar other device, and in specific embodiments, are easily reconstituted by the intended user with a suitable aqueous liquid, typically water, to form a nutritional composition for immediate oral or enteral use. In this context, “immediate” use generally means within about 48 hours, most typically within about 24 hours, preferably right after reconstitution.

The nutritional powders in specific embodiments are reconstituted with water prior to use to a caloric density tailored to the nutritional needs of the ultimate user. In specific embodiments the powder(s) is/are reconstituted with water to form compositions comprising at least 19 kcal/fl oz (660 kcal/liter), or from about 20 kcal/fl oz (675-680 kcal/liter) to about 25 kcal/fl oz (820 kcal/liter), or from about 20 kcal/fl oz (675-680 kcal/liter) to about 24 kcal/fl oz (800-810 kcal/liter). In some embodiments, the reconstituted powder in specific embodiments has a caloric density from about 50-100 kcal/liter to about 660 kcal/liter, or from about 150 kcal/liter to about 500 kcal/liter. In some specific embodiments, the emulsion in specific embodiments has a caloric density of 25, or 50, or 75, or 100 kcal/liter. Embodiments described herein are used in chronic tube feeding of adults, and include from about 1000 kcal/liter to about 1500 kcal/liter, or from about 1000 kcal/liter to about 2000 kcal/liter, or from about 1200 to about 1800 kcal/liter. Certain embodiments envision target volumes per day of about 750 to about 1500 ml, administered in multiple, divided boluses, the divided bolus volume determined by patient volume tolerance, each bolus intended to deliver an effective dosage to reduce inflammation.

The nutritional compositions in specific embodiments are alternatively in the form of solid nutritional bars and food products. For example, the nutritional compositions in specific embodiments are formulated as bars, sticks, cookies, breads, cakes, or other baked goods.

### Rice Protein Hydrolysates

The compositions and methods of the present disclosure include at least one, and in certain embodiments, a combination of more than one rice protein hydrolysate. The rice protein hydrolysates are preferably derived from food acceptable protein sources. Particularly, it has been surprisingly found that by controlling the hydrolysis of a rice protein, the rice protein hydrolysate has anti-inflammatory properties, without adversely affecting the flavor attributes of compositions including the hydrolysate.

### Rice Protein Hydrolysate

In certain exemplary embodiments, the nutritional compositions comprise rice protein hydrolysate as a primary or sole source of protein. The rice protein hydrolysates used in the compositions of the present disclosure have been found to show surprising anti-inflammatory properties and improved flavor and organoleptic properties as compared to other protein hydrolysates, including more extensively hydrolyzed proteins. Thus, the rice protein hydrolysates provide a good source of protein for nutritional compositions that are designed for individuals who have inflammatory conditions or diseases. These nutritional compositions further have improved flavor and emulsion stability.

In certain exemplary embodiments, the rice protein is a moderately hydrolyzed rice protein. Specific embodiments of moderately hydrolyzed rice proteins are those having a degree of hydrolysis from above 15% to 30%, or from about 16% to about 29%, or from about 17% to about 28%, or from about 18% to about 27%, or from about 20% to about 27%. In specific embodiments the moderately hydrolyzed rice protein has degree of hydrolysis from about 20% to about 25%, or about 22% to about 24%. Moderately hydrolyzed rice proteins have surprisingly demonstrated efficacy at modulating and/or reducing the late phase of the inflammatory response. This is in contrast to intact proteins which do not affect the inflammatory response in this fashion. In addition, alternative sources of moderately hydrolyzed protein (e.g., potato protein hydrolysates, certain milk-derived hydrolysates) also lack this ability to modulate a late phase of the inflammatory response. Specific embodiments of moderately hydrolyzed rice proteins are those having a degree of hydrolysis of at least 20%, or at least 25%, or at least 30%. Specific embodiments of moderately hydrolyzed rice proteins are those having a degree of hydrolysis from at least 25% to about 40%.

The rice protein hydrolysates in specific embodiments are the sole source of protein in the nutritional compositions of the present disclosure. Alternatively, additional protein sources, as described below, in specific embodiments are used in the compositions in combination with the rice protein hydrolysates to provide the total protein. Accordingly, the rice protein hydrolysate in specific embodiments provides at least 50% of the total protein by weight in the nutritional composition, or from about 50% to about 100% of the total protein, or from about 60% to about 95% of the total protein, or from about 70% to about 90% of the total protein, or from about 75% to about 85% of the total protein in the nutritional composition. As noted herein, the additional protein sources in specific embodiments include partially hydrolyzed, hydrolyzed, unhydrolyzed (intact) proteins, and/or a combination thereof. Rice protein hydrolysate in specific embodiments provides from about 0.15% to about 1.5% of the total protein by weight in the nutritional composition. In specific embodiments 3.6% by weight of the product is protein, and 1.8% of the total weight of the product is from rice protein hydrolysate. In specific embodiments from about 1.8% to about 5% of the product by weight is rice protein hydrolysate, or from about 1.5% to about 6%.

In specific embodiments brown rice is moderately hydrolyzed. In specific embodiments nutritional compositions for modulating or reducing inflammation in an individual contain hydrolyzed rice proteins derived from brown rice.

### Long Chain Polyunsaturated Fatty Acids (LCPIUFAs)

In addition to the rice protein hydrolysates described above, specific embodiments of the nutritional compositions of the present disclosure include LCPUFAs. LCPUFAs are included in the nutritional compositions to provide nutritional support, as well as to reduce oxidative stress and enhance growth and functional development of a variety of biological and immune functions. In some embodiments, the nutritional composition includes a combination of rice protein hydrolysates and LCPUFAs such that the composition provides a synergistic benefit to the end user, such as a synergistic benefit in modulating or dampening inflammation.

Exemplary LCPUFAs for use in the nutritional compositions include, for example, ω-3 LCPUFAs and ω-6 LCPUFAs. Specific LCPUFAs include docosahexaenoic acid (DHA), eicosapentaenoic acid (EPA), docosapentaenoic acid (DPA), arachidonic acid (ARA), linoleic acid, linolenic acid (alpha linolenic acid) and gamma-linolenic acid derived from oil sources such as plant oils, marine plankton, fungal oils, and/or fish oil, and a combination thereof.

In order to reduce potential side effects of high dosages of LCPUFAs in the nutritional compositions, the content of LCPUFAs preferably does not exceed 3% by weight of the total fat content (such as from about 0.5% to about 3%), including below 2% by weight of the total fat content, and including below 1% by weight of the total fat content in the nutritional composition.

The LCPUFA in specific embodiments is provided as free fatty acids, in triglyceride form, in diglyceride form, in monoglyceride form, in phospholipid form, in esterfied form, or as a mixture of one or more of the above, preferably in triglyceride form.

### Polyphenols

In addition to the rice protein hydrolysates described above, the nutritional compositions of the present disclosure in specific embodiments include polyphenols. Polyphenols are included in the nutritional compositions to provide nutritional support, as well as to enhance growth and functional development of a variety of biological and immune functions. In some embodiments, the nutritional composition includes a combination of rice protein hydrolysates and polyphenols such that the composition provides a synergistic benefit to the end user, such as a synergistic benefit in modulating or dampening inflammation.

Polyphenols, as used herein, are a structural class of mainly natural, but also synthetic or semi-synthetic, organic chemicals characterized by the presence of large multiples of phenol structural units. In particular, the term polyphenol refers to biologically active phytochemicals, such as those that arise in wine, tea, and, for example, the extracts of certain fruits.

### Curcuminoid

In addition to the rice protein hydrolysates described above, the nutritional compositions of the present disclosure in specific embodiments include curcuminoids. Curcuminoids are included in the nutritional compositions to provide nutritional support, as well as to reduce inflammation and enhance growth and functional development of a variety of biological and immune functions. In some embodiments, the nutritional composition includes a combination of rice protein hydrolysates and curcuminoids such that the composition provides a synergistic benefit to the end user, such as a synergistic benefit in modulating or dampening inflammation.

Curcumin is the principal curcuminoid found in turmeric and is responsible for the yellow color of the spice. The term “curcuminoid,” as used herein, refers to curcumin and derivatives thereof and analogs thereof. These include natural and synthetic derivatives of curcumin, and any combination of more than one curcuminoid. In particular, for the purposes herein, the term “curcuminoid” should be understood to encompass compounds having a 1,7-bis (4-hydroxyphenyl)-1,6-heptadiene-3,5-dione or 1,7-bis(4-hydroxyphenyl)hept-4-en-3-one skeleton wherein the phenyl groups independently in specific embodiments bear one or more alkoxy residues, and in specific embodiments have one methoxy residue in the 3-position.

Specific naturally occurring curcuminoids comprise curcumin (1,7-Bis-(4-hydroxy-3-methoxyphenyl)-hepta-1,6-diene-3,5-dione), desmethoxycurcumin (1-(4-Hydroxyphenyl)-7-(4-hydroxy-3-methoxyphenyl)-hepta-1,6-diene-3,5-dione) and bis-desmethoxycurcumin (1,7-Bis-(4-hydroxyphenyl)-hepta-1,6-di ene-3,5-dione). Nutritional compositions described herein can contain one, more than one, or a combination of these naturally occurring curcuminoids, which can be added as a powder or emulsified into the nutritional composition.

### Antioxidants

In addition to the rice protein hydrolysates described above, the nutritional compositions of the present disclosure in specific embodiments include antioxidants to provide nutritional support, as well as to reduce oxidative stress. In some embodiments, the nutritional composition includes a combination of rice protein hydrolysates and antioxidants such that the composition provides a synergistic benefit to the end user, such as a synergistic benefit in modulating or dampening inflammation.

Any antioxidants suitable for oral administration in specific embodiments are included for use in the nutritional compositions of the present disclosure, including, for example, vitamin A, vitamin E, vitamin C, retinol, tocopherol, and carotenoids, including lutein, beta-carotene, zeaxanthin, and lycopene, and a combination thereof, for example.

As noted, the antioxidants for use in the nutritional compositions in specific embodiments are used with the rice protein hydrolysates alone or in combination with other optional ingredients. In one specific embodiment, the antioxidants for use in the nutritional compositions include carotenoids, and particularly, combinations of the carotenoids lutein, lycopene, zeaxanthin and/or beta-carotene.

The nutritional compositions in specific embodiments comprise at least one of lutein, lycopene, zeaxanthin, and beta-carotene to provide a total amount of carotenoid from about 0.001 μg/mL to about 10 μg/mL. The nutritional compositions in specific embodiments comprise at least one of lutein, lycopene, zeaxanthin, and/or beta-carotene in an amount from about 0.001 μg/mL to about 10 μg/mL. Other carotenoids in specific embodiments are optionally included in the nutritional compositions as described herein.

### Macronutrients

The nutritional compositions including the hydrolyzed rice protein in specific embodiments are formulated to include macronutrients such as protein, fat, and/or carbohydrate. In many embodiments, the nutritional compositions will include the hydrolyzed rice protein with carbohydrate, fat, and/or one or more additional source of protein.

The amount of each macronutrient in any of the liquid nutritional compositions described herein in specific embodiments are characterized in addition to, or in the alternative, as a percentage of total calories in the liquid nutritional composition as set forth in the following table (each numerical value is preceded by the term “about”).

TABLE 1
Liquid

| Percentage of | | | |
|---|---|---|---|
| Total Cal. | Embodiment A | Embodiment B | Embodiment C |
| Carbohydrate | 0-98 | 2-96 | 10-75 |
| Protein | 0-98 | 2-96 | 5-70 |
| Fat | 0-98 | 2-96 | 20-85 |
| | Embodiment D | Embodiment E | Embodiment F |
| Carbohydrate | 30-50 | 25-50 | 25-50 |
| Protein | 15-35 | 10-30 | 5-30 |
| Fat | 35-55 | 1-20 | 2-20 |

The total amount or concentration of each macronutrient in the powdered nutritional compositions of the present disclosure varies considerably depending upon the selected composition and dietary or medical needs of the intended user. Additional suitable examples of macronutrient concentrations are set forth below. In this context, the total amount or concentration refers to all protein, fat, and carbohydrate sources in the powdered composition. For powdered nutritional compositions, such total amounts or concentrations in specific embodiments are formulated within any of the caloric ranges (embodiments J-L) described in the following table (each numerical value is preceded by the term “about”).

TABLE 2
Powdered

| Percentage of | | | |
|---|---|---|---|
| Total Cal. | Embodiment J | Embodiment K | Embodiment L |
| Carbohydrate | 1-85 | 30-60 | 35-55 |
| Fat | 5-70 | 20-60 | 25-50 |
| Protein | 2-75 | 5-50 | 7-40 |

### Protein

The nutritional compositions of the present disclosure in specific embodiments further comprise at least one additional source of protein in addition to the rice protein hydrolysates. The amount of protein present in the nutritional composition in specific embodiments varies widely and in specific embodiments is based on the particular needs of the intended consumer or the intended product form.

When used in a nutritional liquid, the total protein concentration in the nutritional liquid in specific embodiments ranges from 0.25% to about 55%, or about 0.5% to about 45%, or from about 1% to about 30%, or from about 5% to about 25%, or from about 10% to about 20%, or from about 12% to about 18%, by weight of the nutritional liquid composition.

When used in solid nutritional compositions, such as nutritional powders, bars, and other food products, the total protein concentration in the solid nutritional compositions in specific embodiments ranges from about 1.0% to about 50%, or from about 5% to about 50%, or from about 10% to about 40%, or from about 20% to about 35% by weight of the solid nutritional composition.

Non-limiting examples of suitable additional proteins or sources thereof for use in the nutritional compositions include hydrolyzed, partially hydrolyzed, or non-hydrolyzed proteins or protein sources, which in specific embodiments are derived from any known or otherwise suitable source such as milk (e.g., casein, whey), animal (e.g., meat, fish), cereal (e.g., rice, corn), vegetable (e.g., soy, pea), or combinations thereof. Non-limiting examples of such proteins include milk protein isolates, milk protein concentrates, casein protein isolates, extensively hydrolyzed casein, whey protein, sodium or calcium caseinates, whole cow milk, partially or completely defatted milk, soy protein isolates, soy protein concentrates, and so forth.

### Fat

The nutritional compositions of the present disclosure in specific embodiments include the LCPUFAs described above, and/or in specific embodiments comprise other or additional source or sources of fat. The amount of fat present in the nutritional composition in specific embodiments varies widely and in specific embodiments is based on the particular needs of the intended consumer or the intended product form.

When used in a nutritional liquid, fat in specific embodiments is present as emulsified fat. The fat in specific embodiments is present in the nutritional liquid beverages in an amount from 0% to about 30%, or from about 5% to about 25%, or from about 10% to about 20%, or from about 12% to about 18%, or from about 15% to about 17%, by weight of the nutritional emulsion.

When used in solid nutritional compositions, the fat in specific embodiments is present in an amount from about 0% to about 35%, or from about 1% to about 20%, or from about 5% to about 15%, or from about 7% to about 10% by weight of the solid nutritional composition.

Non-limiting examples of suitable fats or sources thereof for use in the nutritional compositions described herein include coconut oil, fractionated coconut oil, soybean oil, corn oil, olive oil, safflower oil, high oleic safflower oil, oleic acids, MCT oil (medium chain triglycerides), sunflower oil, high oleic sunflower oil, palm and palm kernel oils, palm olein, canola oil, marine oils, fish oils, fungal oils, algae oils, cottonseed oils, and a combination thereof.

In certain exemplary embodiments, the nutritional composition is desired to be clear, or at least substantially translucent, and is substantially free of fat. As used herein “substantially free of fat” refers to a nutritional composition containing less than 0.5%, including less than 0.1%, fat by weight of the total composition. “Substantially free of fat” in specific embodiments also refers to a nutritional composition disclosed herein that contains no fat, i.e., zero fat. In those embodiments of the nutritional composition that are substantially free of fat but have some amount of fat present, the fat in specific embodiments is present as a result of being inherently present in another ingredient or the fat in specific embodiments is present as a result of being added as one or more separate sources of fat.

### Carbohydrate

The nutritional compositions of the present disclosure in specific embodiments further optionally comprise any carbohydrate(s) that is/are suitable for use in an oral nutritional composition.

Non-limiting examples of suitable carbohydrates or sources thereof for use in the nutritional compositions described herein in specific embodiments include maltodextrin, hydrolyzed or modified starch or cornstarch, glucose polymers, corn syrup, corn syrup solids, rice-derived carbohydrates, pea-derived carbohydrates, potato-derived carbohydrates, tapioca, sucrose, glucose, fructose, lactose, high fructose corn syrup, honey, sugar alcohols (e.g., maltitol, erythritol, sorbitol), artificial sweeteners (e.g., sucralose, acesulfame potassium, stevia), and a combination thereof. A particularly desirable carbohydrate is a low dextrose equivalent (DE) maltodextrin.

In specific embodiments the carbohydrate or carbohydrate component is present in an amount from about 5% to about 65% by weight of the nutritional composition, or from about 20% to about 45%, or from about 25% to about 35% by weight of the nutritional composition.

Non-limiting examples of a source of carbohydrate suitable for use in the nutritional compositions described herein include maltodextrin, hydrolyzed or modified starch or cornstarch, glucose polymers, corn syrup, corn syrup solids, rice-derived carbohydrates, sucrose, glucose, fructose, lactose, high fructose corn syrup, honey, sugar alcohols (e.g., maltitol, erythritol, sorbitol), isomaltulose, sucromalt, pullulan, potato starch, slowly-digested carbohydrates, dietary fibers (e.g., oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low and high methoxy pectin, cereal beta-glucans (e.g., oat beta-glucan, barley beta-glucan), carrageenan, and psyllium), Fibersol™, other resistant starches, and a combination thereof.

### Other Optional Ingredients

The nutritional compositions of the present disclosure in specific embodiments further comprise other optional components that in specific embodiments modify the physical, chemical, aesthetic, or processing characteristics of the products or serve as pharmaceutical or additional nutritional components when used in the targeted population.

Non-limiting examples of such optional ingredients include preservatives, emulsifying agents, buffers, fructooligosaccharides, galactooligosaccharides, polydextrose, and other prebiotics, probiotics, pharmaceutical actives, additional nutrients as described herein, colorants, flavors, thickening agents and stabilizers, lubricants, and so forth.

The nutritional compositions in specific embodiments further comprise a sweetening agent, preferably including at least one sugar alcohol such as maltitol, erythritol, sorbitol, xylitol, mannitol, isolmalt, and lactitol, and also preferably including at least one artificial or high potency sweetener such as acesulfame K, aspartame, sucralose, saccharin, stevia, and tagatose. These sweetening agents, especially as a combination of a sugar alcohol and an artificial sweetener, are especially useful in formulating liquid beverage embodiments of the present disclosure having a desirable favor profile. These sweetener combinations are especially effective in masking undesirable flavors sometimes associated with the addition of vegetable proteins to a liquid beverage. Sugar alcohol concentrations in the nutritional composition in specific embodiments range from at least about 0.01% to about 10%, or from about 1% to about 6%, by weight of the nutritional composition. Artificial sweetener concentrations in specific embodiments range from about 0.01% to about 5%, or from about 0.1% to about 1.0%, by weight of the nutritional composition.

A flowing agent or anti-caking agent in specific embodiments is included in the nutritional compositions as described herein to retard clumping or caking of the powder over time and to make a powder embodiment flow easily from its container. Any known flowing or anti-caking agents that are known or otherwise suitable for use in a nutritional powder or product form are suitable for use herein, non-limiting examples of which include tricalcium phosphate, silicates, and combinations thereof. The concentration of the flowing agent or anti-caking agent in the nutritional composition varies depending upon the product form, the other selected ingredients, the desired flow properties, and so forth, but in specific embodiments, range from about 0.1% to about 4%, or from about 0.5% to about 2%, by weight of the nutritional composition.

A stabilizer in specific embodiments is also included in the nutritional compositions. Any stabilizer that is known or otherwise suitable for use in a nutritional composition is also suitable for use herein, some non-limiting examples of which include gums such as xanthan gum. The stabilizer in specific embodiments represents from about 0.1% to about 5.0%, or from about 0.5% to about 3%, or from about 0.7% to about 1.5%, by weight of the nutritional composition.

The nutritional compositions in specific embodiments further comprise any of a variety of other vitamins or related nutrients, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and a combination thereof.

The nutritional compositions in specific embodiments further comprise any of a variety of other additional minerals, non-limiting examples of which include calcium, phosphorus, magnesium, iron, zinc, manganese, copper, sodium, potassium, molybdenum, chromium, chloride, and a combination thereof.

### Methods of Manufacture

The nutritional compositions of the present disclosure in specific embodiments are prepared by any known or otherwise effective manufacturing technique for preparing the selected product solid or liquid form. Many such techniques are known for any given product form such as nutritional liquids or powders and in specific embodiments are easily applied by one of ordinary skill in the art to the nutritional compositions described herein.

The nutritional compositions of the present disclosure are in specific embodiments prepared by any of a variety of known or otherwise effective formulation or manufacturing methods. In one suitable manufacturing process, for example, at least three separate slurries are prepared, including a protein-in-fat (PIF) slurry, a carbohydrate-mineral (CHO-MIN) slurry, and a protein-in-water (PIW) slurry. The PIF slurry is formed by heating and mixing the oil (e.g., canola oil, corn oil, etc.) and then adding an emulsifier (e.g., lecithin), fat soluble vitamins, and a portion of the total protein (e.g., rice protein hydrolysate, etc.) with continued heat and agitation. The CHO-MIN slurry is formed by adding with heated agitation to water: minerals (e.g., potassium citrate, dipotassium phosphate, sodium citrate, etc.), trace and ultra trace minerals (TM/UTM premix), thickening or suspending agents (e.g. avicel, gellan, carrageenan). The resulting CHO-MIN slurry is held for 10 minutes with continued heat and agitation before adding additional minerals (e.g., potassium chloride, magnesium carbonate, potassium iodide, etc.), and/or carbohydrates (e.g., HMOs, fructooligosaccharide, sucrose, corn syrup, etc.). The PIW slurry is then formed by mixing with heat and agitation the remaining protein, if any.

The resulting slurries are then blended together with heated agitation and the pH adjusted to 6.6-7.0, after which the composition is subjected to high-temperature short-time (HTST) processing during which the composition is heat treated, emulsified and homogenized, and then allowed to cool. Water soluble vitamins and ascorbic acid are added, the pH is adjusted to the desired range if necessary, flavors are added, and water is added to achieve the desired total solid level. The composition is then aseptically packaged to form an aseptically packaged nutritional emulsion. This emulsion in specific embodiments may then alternatively be further diluted, heat-treated, and packaged to form a ready-to-feed or concentrated liquid. Alternatively, the product may be produced by first making a base powder and subsequently adding the hydrolyzed rise protein via drymixing techniques to produce the final product for packaging.

The nutritional solid, such as a spray dried nutritional powder or drymixed nutritional powder, in specific embodiments is prepared by any collection of known or otherwise effective technique, suitable for making and formulating a nutritional powder. Drying methods may also include rotating drum drying, fluid bed drying, belt drying technologies, and so forth.

For example, when the nutritional powder is a spray dried nutritional powder, the spray drying step in specific embodiments likewise includes any spray drying technique that is known for or otherwise suitable for use in the production of nutritional powders. Many different spray drying methods and techniques are known for use in the nutrition field, all of which are suitable for use in the manufacture of the spray dried nutritional powders herein.

One method of preparing the spray dried nutritional powder comprises forming and homogenizing an aqueous slurry or liquid comprising predigested fat, and optionally protein, carbohydrate, and other sources of fat, and then spray drying the slurry or liquid to produce a spray dried nutritional powder. The method in specific embodiments further comprises the step of spray drying, drymixing, or otherwise adding additional nutritional ingredients, including any one or more of the ingredients described herein, to the spray dried nutritional powder.

### Methods of Use

The nutritional compositions as described herein in specific embodiments is used to address one or more of the diseases or conditions discussed herein, or in specific embodiments is used to provide one or more of the benefits described herein. The individual utilizing the nutritional compositions described herein in specific embodiments actually is afflicted with the disease or condition described, or may be susceptible to, or at risk of, getting the disease or condition (that is, may not actually yet have the disease or condition, but is at elevated risk as compared to the general population for getting it due to certain conditions, family history, etc.) Whether the individual actually has the disease or condition, or is at risk or susceptible to the disease or condition, the individual is classified herein as “in need of” assistance in preventing dealing with and combating the disease or condition. For example, the individual in specific embodiments actually has an inflammatory disease or may be at risk of getting inflammatory disease due to family history or other medical conditions, for example.

Based on the foregoing, because some of the method embodiments of the present disclosure are directed to specific subsets or subclasses of identified individuals (that is, the subset or subclass of individuals “in need” of assistance in addressing one or more specific diseases or specific conditions noted herein), not all individuals will fall within the subset or subclass of individuals as described herein for certain diseases or conditions.

### EXAMPLES

The following examples illustrate specific embodiments and/or features of the nutritional compositions of the present disclosure. The examples are given solely for the purpose of illustration and are not to be construed as limitations of the present disclosure, as many variations thereof are possible without departing from the spirit and scope of the disclosure.

### In Vitro Experiments

In vitro experiments have been performed to study the effect of two forms of rice protein hydrolysate (RPH-1 and RPH-2) on murine cells.

TABLE 3

| | Intact Rice | | |
|---|---|---|---|
| | Protein | RPH-1 | RPH-2 |
| | Oryzatein | Oryzatein | Oryzatein |
| | Silk 80 | SG-B/N | SG-B/N |
| | #HZN15002/3657 | #RP35312 | #BNB152215-0 |
| Loss on | 4.5% | 5.5% | 5.3% |
| Drying, % w/w | | | |
| Amino N, | 83 | 494 | 518 |
| μmoles/g (as is) | | | |

MW profile, approximate hydrolysate
distribution, % w/w of soluble protein

| | | | | |
|---|---|---|---|---|
| >5000 | Da | N/A | 15.5 | 20.8 |
| 3001-5000 | Da | | 13.2 | 17.9 |
| 1001-3000 | Da | | 34.8 | 36.5 |
| 500-1000 | Da | | 19.1 | 14.4 |
| <500 | Da | | 17.4 | 10.4 |

| | | | |
|---|---|---|---|
| Total | | 100% | 100% |
| MW median, Da | | 1510 | 2219 |
| Peak area total | 2673 | 83813 | 79009 |
| (mAU-min, 205 nm) | | | |

Table 3 provides a comparison of three groups: intact rice protein (Oryzatein SG-B, RPH-1 (Oryzatein SG-B/N # RP35312) and RPH-2 (Oryzatein SG-B/N # BNB15215-0). RPH-1 and RPH-2 are two manufactured lots of Axiom Foods Organic Oryzatein® hydrolyzed rice protein. These two lots of Oryzatein SG-B/N rice protein hydrolysate were tested for loss on drying, amino nitrogen (by TNBS colorimetry), and for molecular weight (MW) profile. A single lot of Oryzatein Silk 80 rice protein concentrate was also tested for loss on drying and for amino nitrogen. The MW profile data refers to the soluble protein only (much of the Oryzatein SG-B/N protein is insoluble in water). Solubility was calculated as the average solubility obtained by two different methods: (a) size exclusion chromatography and (b) amino acid analysis of the soluble component versus the whole hydrolysate. The method used follows a published method (Food Chem, 125 [2011] 1041-1050).

TABLE 4

| | | |
|---|---|---|
| | RPH-1 | RPH-2 |
| MW Range, | Oryzatein SG-B/N | Oryzatein SG-B/N |
| Daltons | #RP35312 | #BNB152215-0 |

| | | | |
|---|---|---|---|
| >5000 | Da | 13.9% | 26.4% |
| 3001-5000 | Da | 14.8% | 17.9% |
| 1001-3000 | Da | 37.8% | 34.8% |
| 500-1000 | Da | 18.9% | 12.7% |
| <500 | Da | 14.6% | 8.2% |

| | | |
|---|---|---|
| Total | 100.0% | 100% |
| MW median, Da | 1593 | 2572 |
| DH Estimate | 15% | 11% |

Table 4 shows a replicate experiment of results of Table 3, showing another comparison of two manufactured lots of Axiom Foods Organic Oryzatein® hydrolyzed rice protein (RPH-1 and RPH-2). Each was tested for MW profile by the published method (Food Chem, 125 [2011] 1041-1050). The MW profiles in Table 3 and Table 4 were determined for the same two lots of the rice hydrolysate. The MW median averages of Tables 3 and 4 are RPH-1=1552 Daltons and RPH-2=2396 Daltons, and the corresponding DH values would (still) be RPH-1=15% and RPH-2=11%.

As shown in Table 3 and Table 4, RPH-1 has a higher amount of smaller peptides (<500 and 500-1000 Da) and a lower amount of larger peptides (3000-5000 and >5000 Da) versus RPH-2. This is consistent with the fact that RPH-1 has a higher degree of hydrolysis (15%) versus 11% for RPH-2. This higher degree of hydrolysis translates into more peptide bonds being cleaved resulting in a greater number of smaller peptides. Therefore active components of RPH-1 likely reside within this smaller peptide mix. In specific embodiments at least 30%° of the rice protein hydrolysate peptides are less than 1000 Da. In specific embodiments the rice protein hydrolysate comprises from about 30% to about 50% of peptides that are less than 1000 Da, or from about 30 to about 40%, or from about 33-38%. In specific embodiments at least 14% of the rice protein hydrolysate peptides are less than 500 Da. In specific embodiments the rice protein hydrolysate comprises from about 12% to about 30% of peptides that are less than 500 Da, or from about 14% to about 25%, or from about 14% to about 18%, or from about 15% to about 17%.

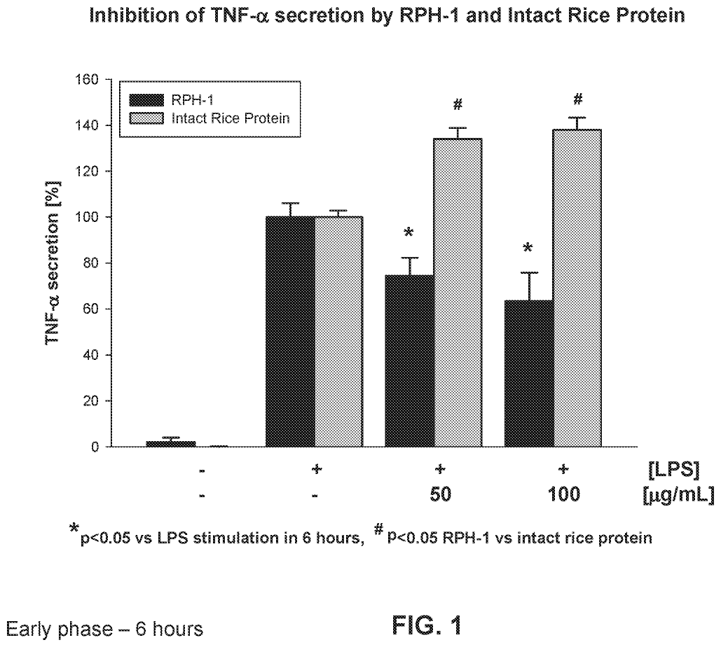

Specific studies have determined effects of the hydrolysates on TNFα secretion, 4-1BBL expression, and NF-κB Expression in murine macrophages (RAW 264.7 cells) treated with LPS (see FIGS. 1-13).

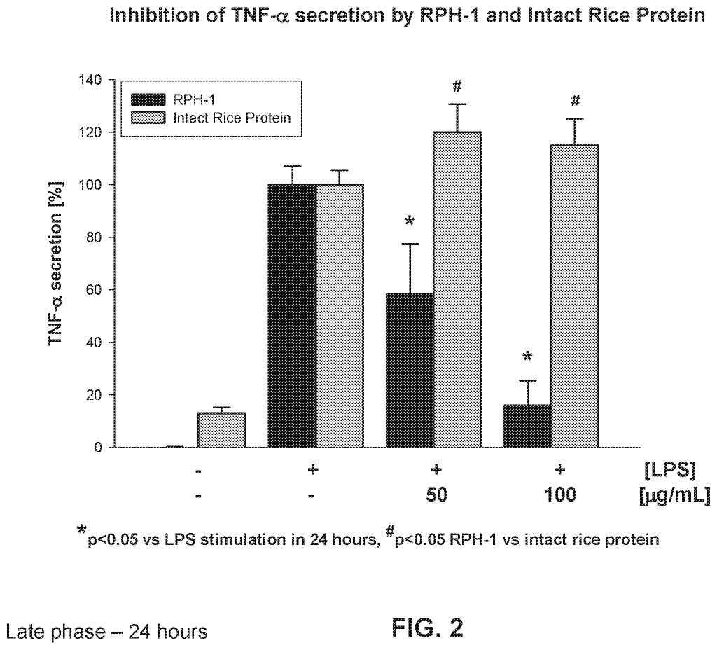

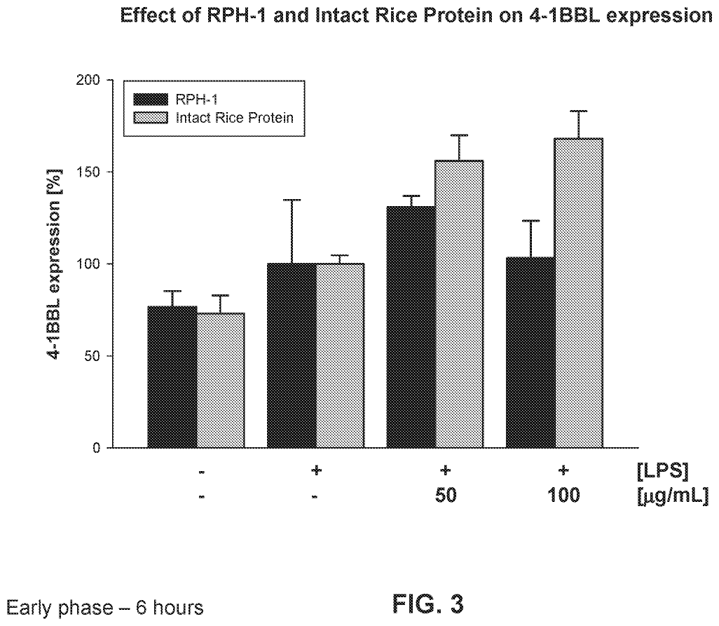

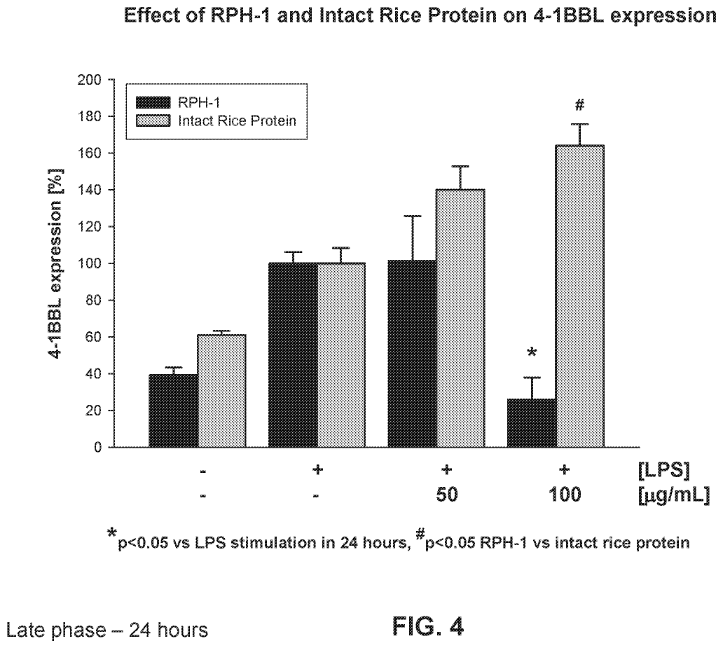

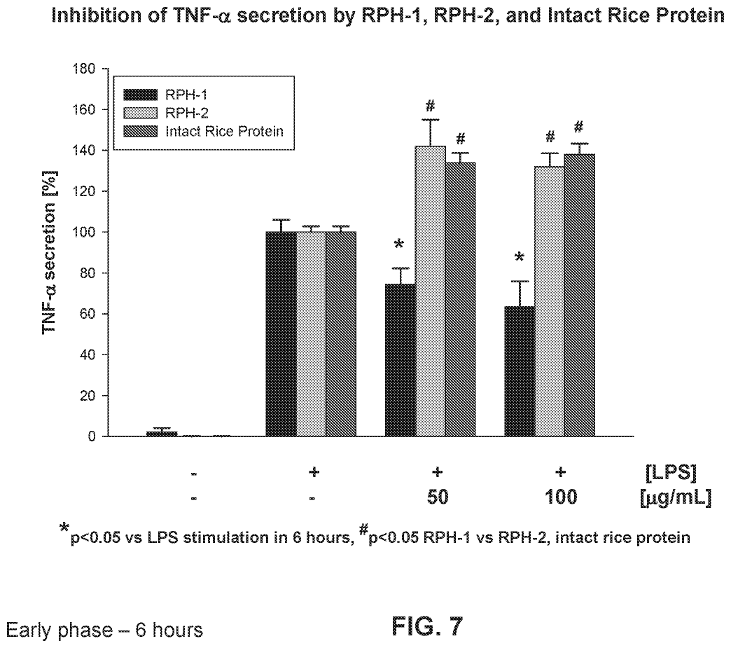

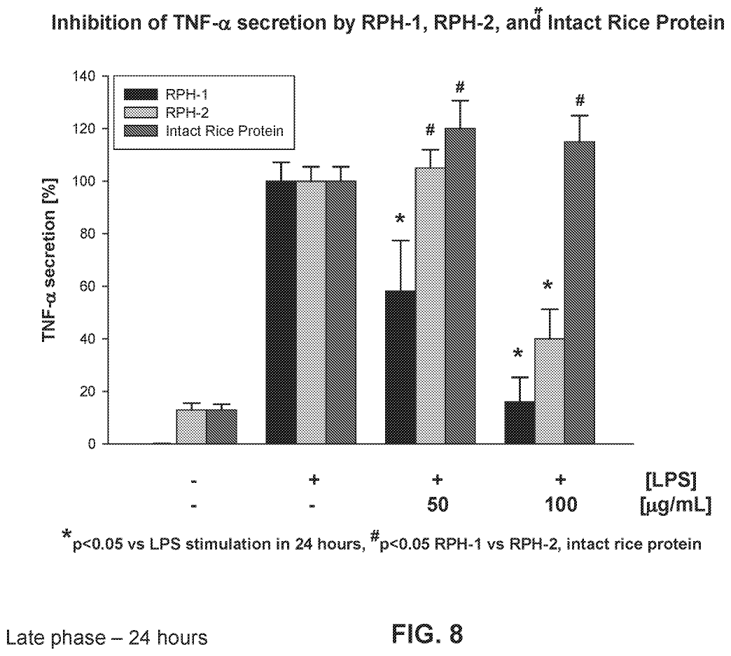

RPH-1 inhibits early and late phase TNFα secretion from cells in culture. FIGS. 1 and 7 illustrate early phase inhibition of TNFα secretion from RAW 264.7 cells in culture treated with LPS (1 μg/ml) following preincubation with RPH-1 for 1 hour (50 μg/mL or 100 μg/mL) as compared with TNFα secretion following preincubation with intact rice protein. At 6 hours following treatment with LPS, a statistically significant decrease in TNFα inhibition occurred with RPH-1 preincubation (FIGS. 1 and 7). An even more pronounced inhibition occurred at 24 hours following LPS treatment (see FIGS. 2 and 8). RPH-1 preincubation also resulted in a statistically significant decrease in 4-1BBL expression 24 hours after treatment (FIG. 4), though no significant differences were seen at the 6 hour time point (FIG. 3).

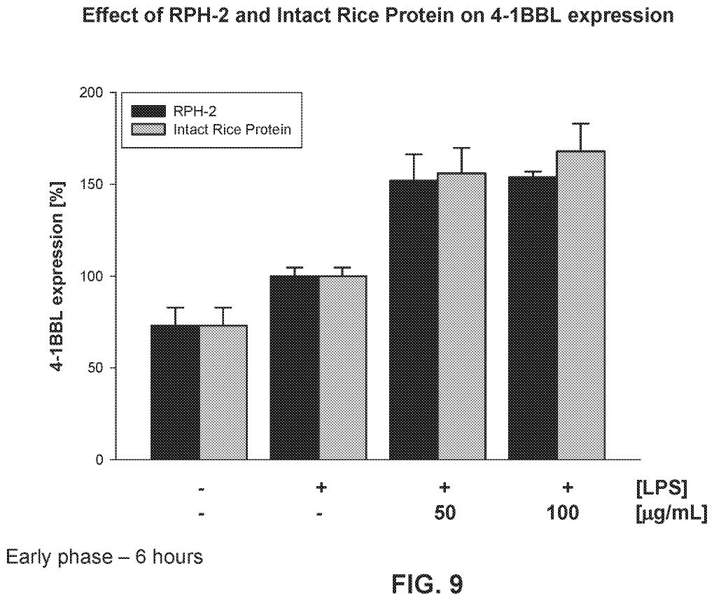

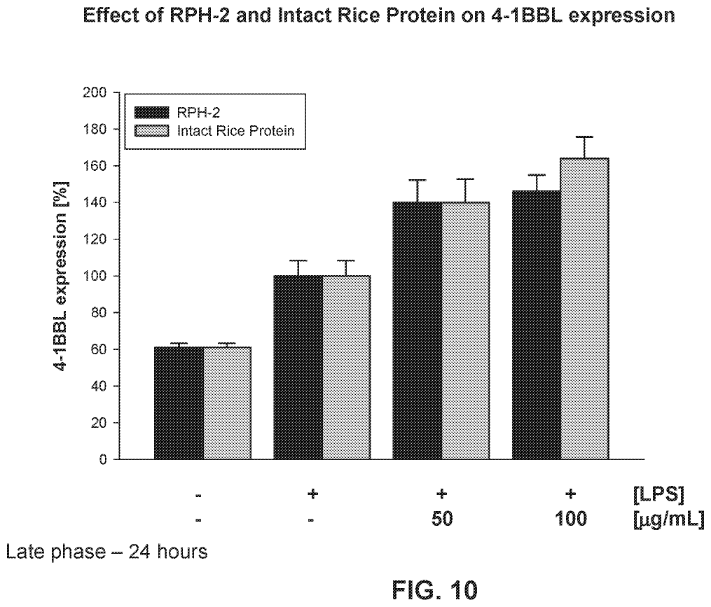

Pretreatment with RPH-2 for 1 hour did not affect LPS-induced TNFα secretion from cells at 6 hours (FIG. 7), through at 24 hours a statistically significant decrease in TNFα secretion was seen at an RPH-2 level of 100 μg/mL (FIG. 8). RPH-2 pretreatment for 1 hour also did not affect either early or late phase LPS-induced 4-1BBL expression (FIGS. 9-10).

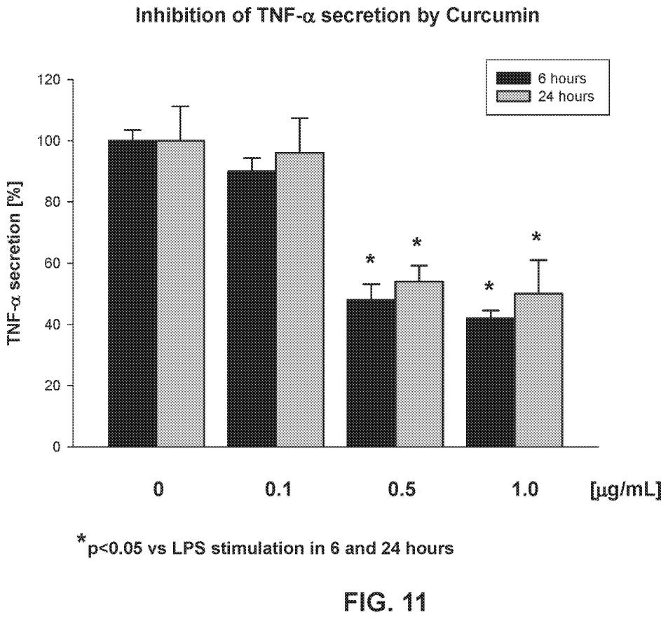

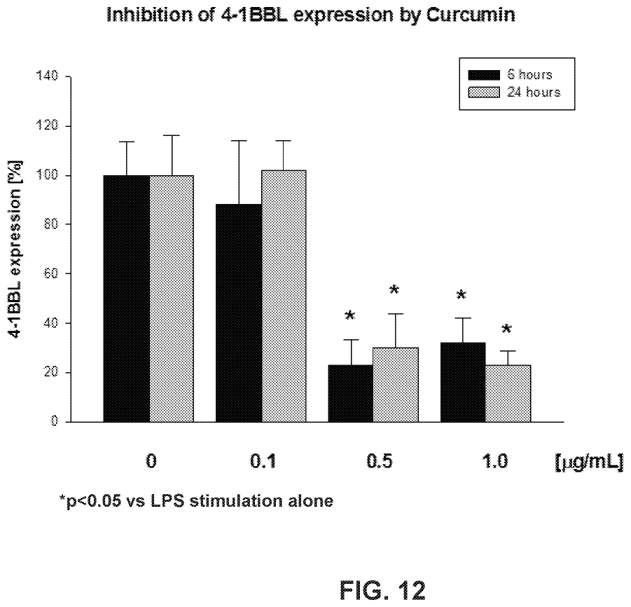

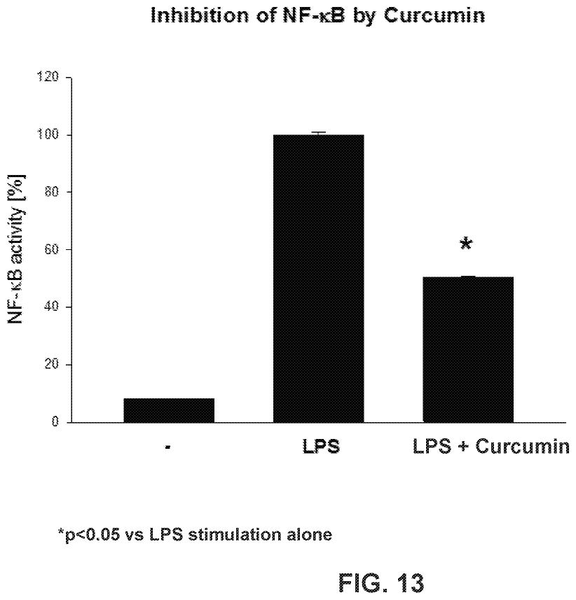

Pretreatment with curcumin at 0.5 μg/mL and 1.0 g/mL for 1 hour led to an inhibition of TNFα secretion (FIG. 11) and 4-IBBL expression (FIG. 12) at 6 hours and 24 hours following LPS treatment. Curcumin pretreatment 2.5 μg/mL for 2 hours also decreased LPS-induced NF-κB expression measured 30 min after LPS stimulation (FIG. 13).

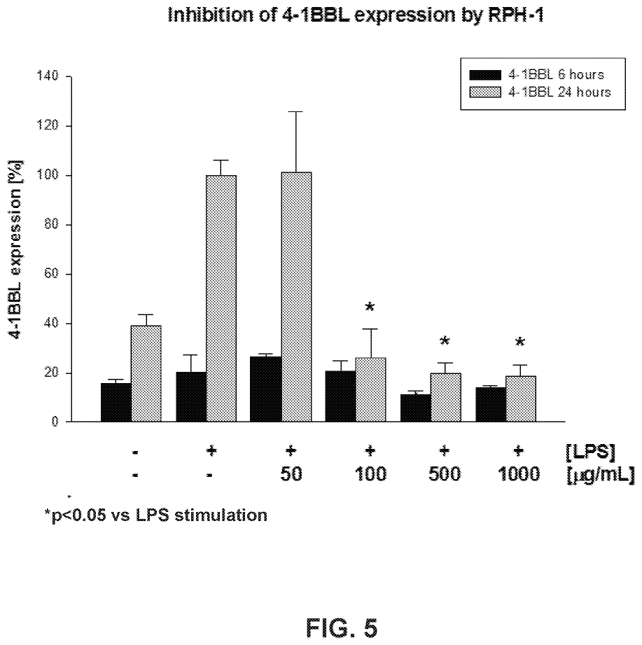

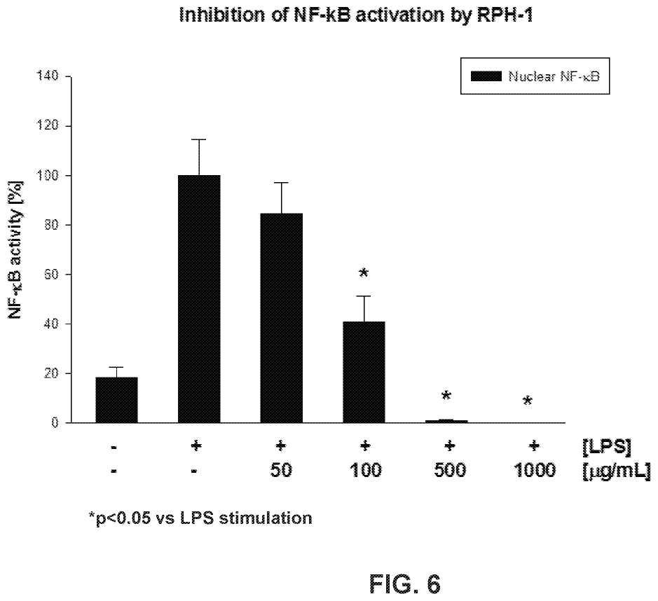

In additional experiments, RPH-1 preincubation also resulted in a statistically significant decrease in 4-1BBL expression 24 hours after treatment when applied at levels from 100-1000 micrograms (FIG. 5). RPH-1 pretreatment for 2 hours also decreased LPS-induced NF-κB at levels from 100-1000 micrograms per mL (FIG. 6).

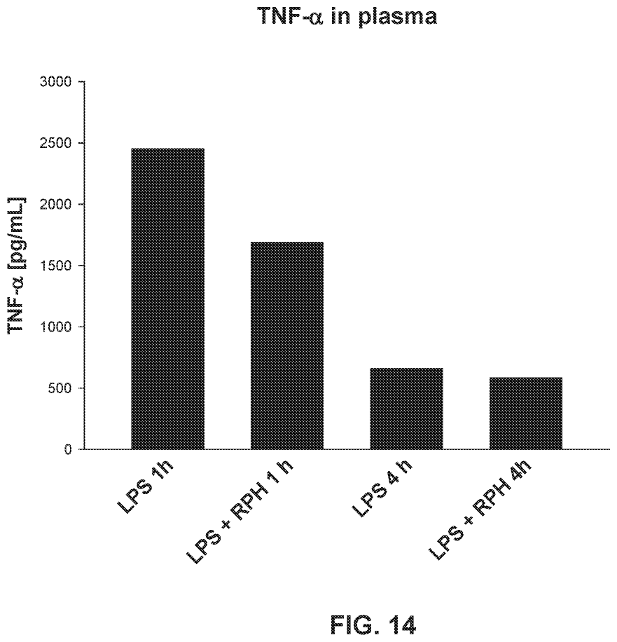

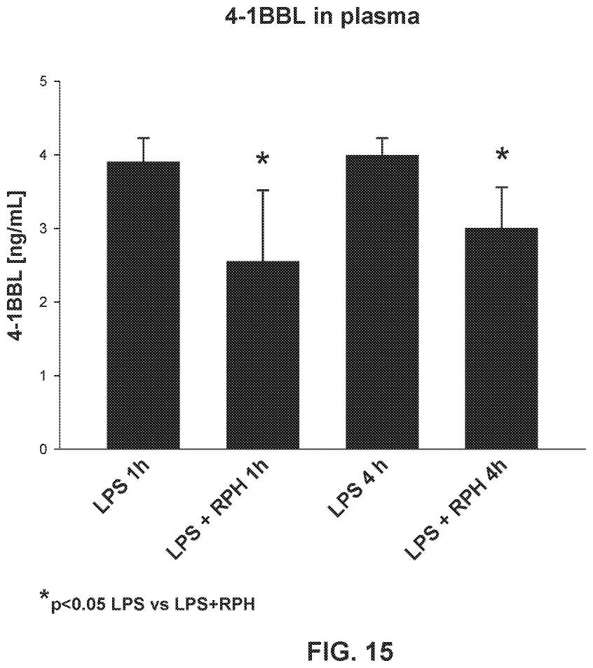

Animal experiments demonstrated that 1 hour pretreatment with RPH-1 (2.5 mg/kg) decreased LPS-induced (1.5 mg/kg i.p.) median levels of TNFα in plasma in mice (FIG. 14). In addition, RPH-1 pretreatment also significantly decreased LPS-induced concentration of plasma 4-1BBL in mice (FIG. 15). RPH-1 administration was via intragastric gavage.

### Ready-to-Feed Nutritional Emulsion Examples

Example 1 (Table 5), and Example 2 (Table 6) illustrate ready-to-feed nutritional emulsions of the present disclosure. All ingredient amounts are listed as kilogram per 1000 kilogram batch of product, unless otherwise specified.

### Example 1

TABLE 5

| | Approximate Amount | |
|---|---|---|
| Ingredients | per 100 kg | |
| Organic Mango Puree | 5 | kg |
| Organic Pumpkin Puree | 2.5 | kg |
| Organic Seedless Banana Puree | 11.0 | kg |
| Organic Carrot Juice Concentrate 42 Brix | 1.0 | kg |
| Organic Spinach Puree | 7.0 | kg |
| Organic Broccoli Puree | 3.0 | kg |
| Organic Whole Grain Brown Rice (Oryz- | 7.0 | kg |
| O-Lait) | | |
| Organic Rice Maltodextrins (18 DE) | 2.5 | kg |
| High Oleic Safflower Oil | 2.0 | kg |
| Organic Canola Oil | 1.1 | kg |
| Tuna Oil | 0.07 | kg |
| Soy Lecithin (Non-GMO) | 0.1 | kg |
| Brown Rice Protein Hydrolysate | 0.9 | kg |
| Pea Protein Concentrate | 1.90 | kg |
| (55% of Protein Blend) | | |
| Natural Chicken Broth - Probase | 0.60 | kg |
| C1301 from Essentia - 20% of protein | | |
| Water | 53.9 g | k |
| WSV Premix (XR65637) | 33.3 | g |
| UTM/TM Premix (XR65642) | 0.0 | g |
| Tri-Calcium Phosphate | 378 | g |
| OSV DEK Premix (XR65633) | 6.3 | g |
| Vitamin A Palmitate | 0.0 | g |
| Sodium Chloride | 0.0 | g |
| Chlorine Chloride | 25.5 | g |
| L-Carnitine | 2.1 | g |
| Ascorbic Acid | 100.0 | g |
| Potassium Iodide | 145.0 | mg |
| 50% KOH | 0.22 | kg |

### Example 2

TABLE 6

| Ingredient | kg/1000 kg |
|---|---|
| Water | q.s. |
| Maltrin M100 Corn Maltodextrin | 73.43 |
| Sucrose | 53.74 |
| SPI - Supro 1610 | 40.00 |
| Canola Oil | 17.49 |
| Corn Oil | 5.83 |
| Brown Rice Protein Hydrolysate | 4.00 |
| Potassium Citrate | 3.58 |
| Magnesium Phosphate Dibasic | 3.09 |
| Givaudan N/A Vanilla Flavor #444947 | 2.40 |
| Avicel CL611 | 2.40 |
| Precip. Ca Carbonate, USP | 1.77 |
| Micronized-Tricalcium Phosphate | 1.54 |
| Sodium Chloride | 0.984 |
| N&A Cotton Candy Type Flavor LC-958- | 0.600 |
| 453-5 | |
| Choline Chloride | 0.480 |
| Ascorbic Acid | 0.469 |
| UTM/TM Premix | 0.475 |
| Potassium Chloride | 0.354 |
| 45% KOH | 0.323 |
| Soy Lecithin | 0.287 |
| Myverol 18-06 Monoglyceride | 0.287 |
| Natural FF Caramel Flavor | 0.240 |
| Viscarin SA-359 | 0.150 |
| Seakem RLC Carrageenan - 100229 | 0.100 |
| Liquid Sucralose (25%) - Ross | 0.09000 |
| WSV Vitamin premix | 0.06900 |
| Acesulfame Potassium | 0.06000 |
| Vitamin DEK Premix | 0.059524 |
| Vitamin A Palmitate, USP | 0.007899 |
| Potassium Iodide | 0.000220 |

As shown in Example 1 at Table 5, in specific embodiments, a ready-to-feed nutritional emulsion contains 0.9 kg of rice protein hydrolysate per 100 kg batch of product, though non-limiting embodiments include, for example, ranges such as: from about 0.1 to about 5 kg of rice protein hydrolysate per 100 kg batch of product, or from about 0.5 kg to about 4 kg of rice protein hydrolysate per 100 kg batch of product, or from about 1.5 kg to about 3 kg of rice protein hydrolysate per 100 kg batch of product. Also as shown in Table 5, in specific embodiments, the ready-to-feed ratio of rice protein hydrolysate to water, by weight, is 0.17:1 (0.9 kg of rice protein hydrolysate to 53.9 kg of water), though non-limiting embodiments include, for example, ratios of rice protein hydrolysate to water by weight ranging from about 0.02 to about 0.9 (such as from 0.05 to about 0.6, or from about 0.1 to about 0.3). As shown in Example 2 at Table 6, in a specific example the rice protein hydrolysate is 4 kg per 1000 kg batch of product, though in other non-limiting embodiments the range could be from about 1 kg to about 6 kg per 1000 kg batch of product, or from about 2 kg to about 5 kg per 1000 kg batch of product. In specific embodiments the ready-to-feed product is a vegan product and is devoid of animal products. In specific embodiments of the ready-to-feed product, all proteins and/or oils of the product are from a vegetable, vegetables, or from a source other than animals.

In specific embodiments, 1 gram of hydrolysate as described herein is administered to a human per nutritional composition serving and/or per day, though in specific embodiments the nutritional composition per serving and/or per day is from about 0.01 grams to about 10 grams, or from about 0.1 g to about 5 g, or from about 0.25 g to about 2.5 g, or from about 0.50 g to about 1.75 g, or from about 0.75 g to about 1.25 g. In specific embodiments a single serving or daily serving or servings is/are administered at from about 100 mg to about 1000 mg, or from about 250 mg to about 750 mg, or from about 400 mg to about 600 mg of hydrolysate. In specific embodiments a single serving or daily serving or servings is/are administered at 122 mg for a 60 kg individual. In specific embodiments a single serving or daily serving or servings is/are administered at about 2 mg of hydrolysate per kg individual, including non-limiting examples such as from about 1.5 mg per kg to about 2.5 mg per kg or from about 1.75 mg per kg to about 2.25 mg per kg. In specific embodiments a single serving or daily serving or servings is/are administered at a level or within a range above 2 mg per kg, such as at 3 mg per kg or 3.5 mg per kg. In specific embodiments a single serving or daily serving or servings is/are administered at 100 mg to 200 mg, or from about 110 to about 190 or from about 120 to about 180 mg per day per individual.

1. A nutritional composition for modulating or reducing inflammation in an individual in need thereof, the nutritional composition comprising a rice protein hydrolysate having a minimum degree of hydrolysis of 15%, wherein at least 30% of the rice protein hydrolysate peptides are less than 1000 Da., and no more than 30% of the rice protein hydrolysate peptides are greater than 3000 Da.

2. The nutritional composition of claim 1, further comprising an NF-κB inhibitor.

3. The nutritional composition of claim 2, wherein the NF-κB inhibitor comprises turmeric, lutein, lycopene, zeaxanthin, luteolin, resveratrol, epigallocatechin gallate, quercetin, hydroxytyrosol, tyrosol, astaxanthin, fisetin, conjugated linoleic acid, 6-gingerol, vitamin E, pterostilbine, pycnogenol, an omega-3 fatty acid, genistein, liquiritigenin, liquiritin, ellagic acid, ursolic acid, naringenin, a cocoa polyphenol, eugenol, helenalin, cinnamaldehyde, sulphoraphane, a green tea catechin, or a combination thereof.

4. The nutritional composition of claim 2, wherein the NF-κB inhibitor comprises a long chain polyunsaturated fatty acid, an anthocyanidin, a curcuminoid, an isoflavone, a carotenoid, or a combination thereof.

5. The nutritional composition of claim 4, wherein the curcuminoid comprises curcumin.

6. The nutritional composition of claim 1, further comprising an antioxidant, wherein the antioxidant comprises vitamin A, vitamin E, vitamin C, retinol, tocopherol, a carotenoid, beta-carotene, zeaxanthin, lycopene, or a combination thereof.

7. The nutritional composition of claim 1, wherein the rice protein has a degree of hydrolysis from 15% to 30%.

8. The nutritional composition of claim 1, further comprising a protein, a carbohydrate and a fat.

9. The nutritional composition of claim 1, wherein the composition further comprises at least 120 mg of the rice protein hydrolysate per serving.

10. A method of modulating inflammation in an individual, the method comprising administering to the individual a nutritional composition comprising a rice protein hydrolysate having a minimum degree of hydrolysis of 15%, wherein at least 30% of the rice protein hydrolysate peptides are less than 1000 Da., and no more than 30% of the rice protein hydrolysate peptides greater than 3000 Da.

11. The method of claim 10, wherein the administration of the nutritional composition reduces a level of 4-1BBL in the individual.

12. The method of claim 10, wherein at least 12% of the rice protein hydrolysate peptides are less than 500 Da.

13. The method of claim 10, wherein the nutritional composition further comprises a carbohydrate, a fat, and a protein.

14. The method of claim 10, wherein the nutritional composition further comprises an NF-κB inhibitor.

15. The method of claim 14, wherein the NF-κB inhibitor comprises turmeric, lutein, lycopene, zeaxanthin, luteolin, resveratrol, epigallocatechin gallate, quercetin, hydroxytyrosol, tyrosol, astaxanthin, fisetin, conjugated linoleic acid, 6-gingerol, vitamin E, pterostilbine, pycnogenol, an omega-3 fatty acid, genistein, liquiritigenin, liquiritin, ellagic acid, ursolic acid, naringenin, a cocoa polyphenol, eugenol, helenalin, cinnamaldehyde, sulphoraphane, a green tea catechin, or a combination thereof.

16. The method of claim 10, wherein the nutritional composition further comprises an antioxidant, wherein the antioxidant is vitamin A, vitamin E, vitamin C, retinol, tocopherol, a carotenoid, beta-carotene, zeaxanthin, lycopene, or a combination thereof.

17. The method of claim 10, wherein the rice protein has a degree of hydrolysis from 15% to 30%.

18. The method of claim 10, wherein the nutritional composition comprises at least 120 mg of the rice protein hydrolysate per serving.

19. A method of modulating inflammation in an individual, the method comprising administering to the individual a rice protein hydrolysate having a minimum degree of hydrolysis of 15%, wherein at least 30% of the rice protein hydrolysate peptides are less than 1000 Da., and no more than 30% of the rice protein hydrolysate peptides greater than 3000 Da.

20. The method of claim 19, wherein administration is via a capsule, tablet, pill, or caplet.

21. The method of claim 20, wherein the capsule, tablet, pill, or caplet further comprises curcumin.
